(19) United States
(12) Patent Application Publication
(10) Pub. No.: US 2015/0310199 A1
(43) Pub. Date: Oct. 29, 2015

(54) SECURE DATA ENTRY

(71) Applicant: EchoStar Technologies L.L.C., Englewood, CO (US)

(72) Inventor: Bhavesh Patel, Woodstock, GA (US)

(73) Assignee: EchoStar Technologies L.L.C., Englewood, CO (US)

(21) Appl. No.: 14/261,073

(22) Filed: Apr. 24, 2014

(51) Int. Cl. G06F 21/36; G06F 3/0488

(52) U.S. Cl. CPC G06F 21/36; G06F 3/04886

(57) ABSTRACT

A first computing device is configured to receive a request for validation, to generate, based on the request, a virtual data entry mechanism that includes randomly arranged data entry elements, and to provide the virtual data entry mechanism to a second computing device.

### BACKGROUND INFORMATION

Providing personal, confidential, etc., data from an end-user computing device to a computer server, e.g., via a network such as the Internet, risks such data being intercepted. For example, an end-user may use a virtual or physical keyboard, keypad, etc. to enter individual characters, i.e., letters, numbers, etc., of data to provide information such as usernames, passwords, account numbers, etc. Then, so-called “malware,” e.g., software such as is known as a “keystroke logger” or the like may be surreptitiously installed on an end-user device, and/or keystrokes of an end-user device may be surreptitiously monitored, e.g., via a public wireless network or the like. Accordingly, it is possible for a malefactor to record data entered from an end user computing device may be, and to capture confidential and/or personal information such as usernames, passwords, account numbers, etc. Accordingly, there is a need to provide a mechanism for transmitting data from an end-user device to a remote server that eliminates risks associated with keystrokes being detected.

### BRIEF DESCRIPTION OF THE DRAWINGS

FIG. 1 is a block diagram of an exemplary system for securely providing data from a user device to a remote server.

FIG. 2 is an illustration of an exemplary conventional virtual keyboard.

FIG. 3 is illustration of an exemplary virtual keyboard having a randomized presentation of keys.

FIG. 4 is illustration of a further exemplary virtual keyboard having a randomized presentation of keys.

FIG. 5 illustrates an exemplary process for securely providing data from a user device to a remote server.

### DETAILED DESCRIPTION OF PREFERRED EMBODIMENTS

### Introduction

Disclosed herein is a system for secure data entry. A remote server may request that data, e.g., a username, login, account information, etc., be provided via a network from an end-user device. The server may provide a virtual data entry mechanism including a randomly or pseudo-randomly generated arrangement of data entry elements, e.g., a virtual keyboard or other arrangement of shapes, letters, numbers, etc. in a graphical user interface (GUI) or the like. A user may then provide information requested by the server by selecting one or more of the randomly provided data entry elements without providing keystrokes that can be surreptitiously recorded. Moreover, because the data entry elements are randomly or pseudo-randomly presented, even surreptitiously recording a location on a display of the end-user device selected for a data entry element will not provide information to a spy about the actual data being provided to the server, e.g., a sensitive password, account number, etc.

### System Overview

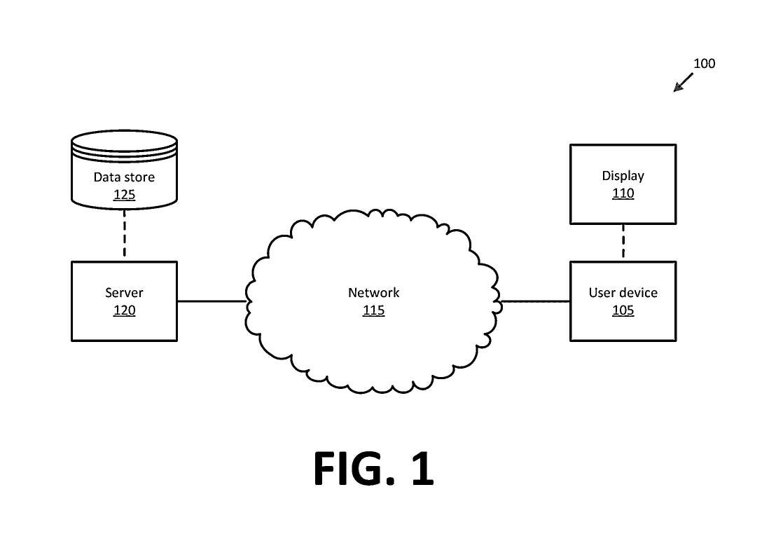

FIG. 1 is a block diagram of an exemplary system 100 for securely providing data from a user device 105 to a remote server 120. The device 105 may include or be coupled to a display 110, the display 110 being capable of displaying a graphical user interface (GUI) or the like generated according to instructions stored in a memory of the device 105. The GUI in the display 110 may include a virtual keyboard, keypad, or other input mechanism, e.g., including selectable data entry elements such as letters, numbers, and/or shapes, etc., for indicating data to be provided via a network 115 to the server 120. A memory of the server 120 may include instructions for generating and providing to the device 105 the virtual input mechanism to be provided in the display 110. For example, the server 120 may be configured to randomly generate data entry elements to be provided via the display 110. The data entry elements may be selected according to data stored in a data store 125 communicatively coupled to, or included in, the server 120.

An end-user device 105 may be any one of a variety of computing devices by which a user may enter data to be provided to a server 120. For example, the end-user device 105 could be a desktop, laptop, tablet, smart phone, etc. computer. In general, the end-user device 105 includes a memory for storing instructions including for carrying out steps as described herein, as well as a processor for executing such instructions. The end-user device 105 may be equipped with various software applications such as a web browser or the like, an application for accessing a banking or other financial account, etc.

The network 110 is generally a packet network, e.g., operating according to transfer control protocol/Internet protocol (TCP/IP). Although one network 115 is shown, the network 115 may include one or more networks, such as the Internet, a wide area network, a local area network, a cellular network, a wireless network, etc.

The server 120 may be one or more computer servers, generally including at least one processor and at least one memory, the memory storing instructions executable by the processor, including instructions for carrying out various of the steps and processes described herein. The data store 125 may be included in the server 120 and/or may be a separate computing device. The data store 125, possible examples of which are discussed further below, generally includes computer-executable instructions for storing and managing data, as well as a computer-readable medium for data storage.

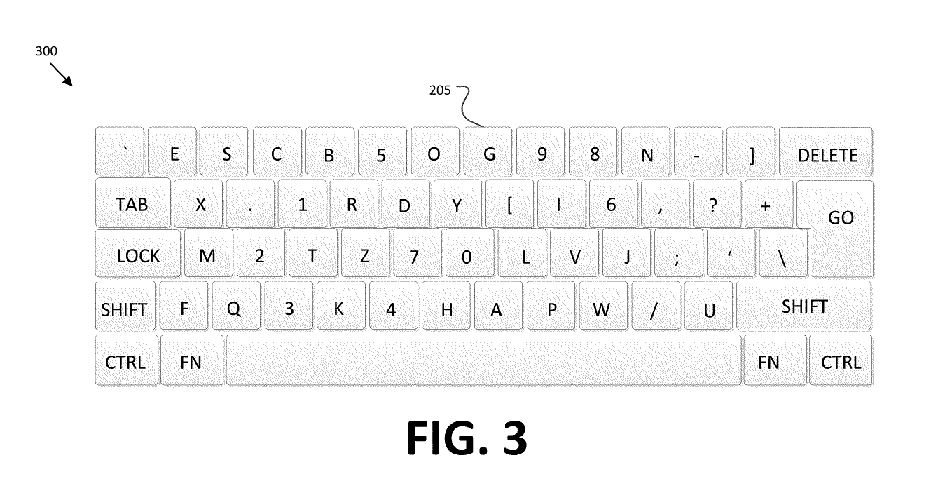

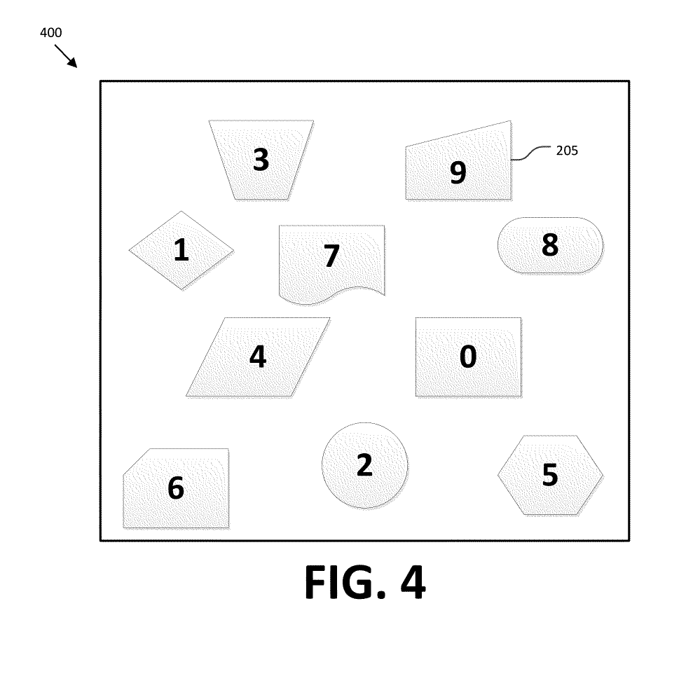

The server 120 generally includes instructions for responding to requests from one or more end-user devices 105. For example, the server 120 may be configured to retrieve requested information from the data store 125, and to provide such requested information in a form appropriate for the requesting end-user device 105, e.g., in a webpage formatted for a mobile device, a webpage formatted for a desktop or laptop computer, in a specialized format for a particular mobile or desktop application, etc. In any case, when the end-user device 105 provides a request that requires the server 120 to collect potentially private and/or confidential information, e.g., usernames, passwords, account numbers, etc., the server 120 may be configured to provide a randomized virtual data entry mechanism as described herein, e.g., as illustrated in FIGS. 3 and 4, discussed below. As is also discussed below, randomizing data entry elements in the data entry mechanism prevents surreptitious monitoring mechanisms, e.g., spyware, from determining a meaning of a selected data entry element according to a location on a display 110 indicated by a user action, e.g., a letter, number, or other character represented by a user selection of the data entry element.

For example, the server 120 may receive a request from a user device 105 to access a bank account, whereupon, based on information in the data store 125, the server 120 will determine that a username, password, and possibly also a personal identification number (PIN) or the like must be collected. The data store 125 may also include metadata or the like indicating that the foregoing information is potentially private and/or confidential. Accordingly, the server 120 may generate a randomized virtual data entry mechanism for collecting such information.

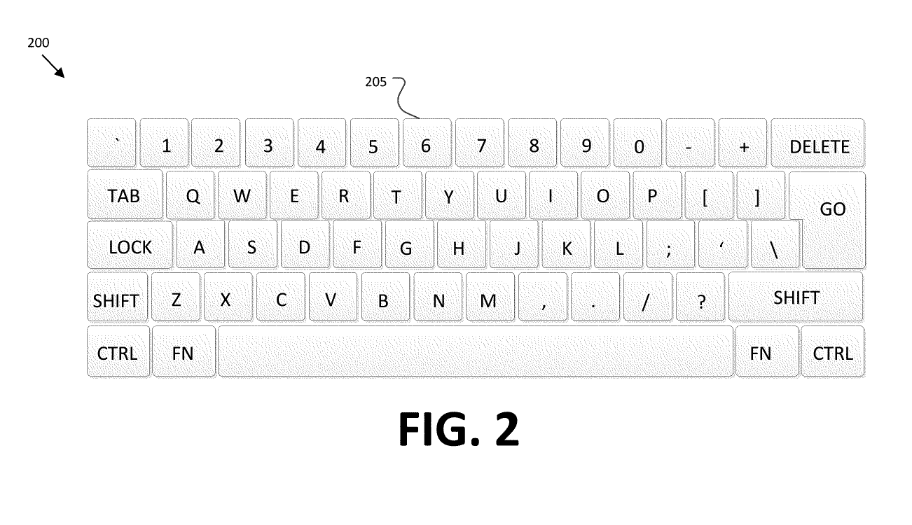

FIG. 2 is an illustration of an exemplary conventional virtual keyboard 200. As can be seen, the keyboard 200 includes a plurality of keys 205, generally arranged in a conventional manner. For example, letters of the alphabet are arranged in a traditional “QWERTY” fashion. The keyboard 200 could be presented on the display 110, whereby a user could select various of the keys 205 via various mechanisms, e.g., physical touch where the display 110 included a touchscreen, a mouse, touchpad, or other pointing device, etc. In general, the virtual keyboard 200 may be provided from the server 122 the user device 105 in the form of a graphics file, e.g., according to a known standard such as PNG, GIF, JPEG, etc. Further, the keyboard 200 may be displayed in a webpage rendered in a standard web browser or the like, whereupon data entry elements such as keys 205 may be selected. However, because the keyboard 200 is arranged in a conventional manner, spy software or the like configured to detect a location of user selections on the display 110, e.g., according to coordinates as determined by pixel rows and/or columns in the display 110, could still be used to infer data entered via the device 105. That is, a particular location on the display 110 could be determined to correspond to a particular key 205 on the keyboard 200, whereby entered data such as a password or account number or the like, could be determined.

The keyboard 300 of FIG. 3 addresses the foregoing difficulty. FIG. 3 is illustration of an exemplary virtual keyboard 300 having a randomized presentation of data entry elements, in this example, keys 205. As can be seen, the keyboard 300 includes all of the letters of the Western alphabet as does the keyboard 200, but in the case of the keyboard 300 the keys 205 representing letters of the alphabet are randomly arranged rather than presented in the traditional “QWERTY” fashion. As explained above, the server 120 may determine, e.g., using data in the data store 125, that a particular data entry mechanism is to be provided, and may accordingly provide such mechanism with randomized data entry elements, e.g., as shown in FIG. 3.

FIG. 4 is illustration of a further exemplary virtual data entry mechanism, a keypad 400, having a randomized presentation of keys 205. In the example of FIG. 4, the digits 0-9 are represented by various shapes randomly arranged on the keypad 400. Further, images of numbers represented by each respective shape are also provided, although implementations are possible where such numbers are not provided.

It is to be understood that, because the server 120 randomly generates a virtual data entry mechanism in response to each individual request from a user device 105, the virtual data entry mechanism, e.g., a keyboard 300, 400, will randomly vary from one request to the next. Accordingly, not only will logging locations on a display 110 selected from a first user device 105 not provide information about specific characters selected, but a surreptitious monitor of selections on one or more devices 105 directed to a same data entry point of a server 120, e.g., a particular account login page or the like, will not thereby be able to detect a pattern from which specific characters entered from one or more devices 105 could be identified.

Further, the examples of FIGS. 3 and 4 are merely illustrative, and not limiting. For example, random colors, shapes, images, etc. could be used to indicate data to be entered in addition to, or in lieu of, keys 205 representing specific characters as shown in the figures. To take one example, shapes or images could be grouped together to represent a particular number, e.g., four small squares or dots, or images of four apples, could represent the number 4. To take another example, images of different items could be presented to correspond to different characters. For example, an apple could correspond to the letter “a,” a banana could correspond to the letter “b,” a cabbage could correspond to the letter “c,” a dragonfly could correspond to the letter “d,” etc. Images of such items could be randomly presented on a display 110, whereupon a user selection of an image could be used to indicate a user selection of the corresponding character.

Yet further for example, it is possible to provide multiple images for entering data such as a password or the like, e.g., images could be shown in a fixed sequence as determined by the server 120, e.g., using a random or pseudo-random mechanism for generating such sequence. For example, five keyboard images could be transmitted, with each keyboard image having at least some keys, e.g., keys representing some or all of the letters of the western alphabet, at different locations. In this example, each time a character entry is received from a user of a device 105, an existing keyboard is replaced in the display 110 with a next keyboard image. The server 120, having stored an order of display of the multiple images, and a map for each of respective locations where characters were displayed, can interpret user input accordingly.

Alternatively, instead of having the server 120 determine an image order, the client 105 can display random keyboard images from a plurality of images provided by the server 120, whereupon, when user input is indicated to be complete (e.g., by the user selecting a “submit” button or the like, the client 105 can provide to the server sends 120 a selected location and an identifier for each of the one or more images selected by the client 105, where an order of identifiers provided to the server 120 can indicate an order in which the images were provided on the display 110. Because the server 120 generated the images and has stored a mapping of image locations to characters or the like, the server 120 can then interpret the provided user input.

### Process Flow

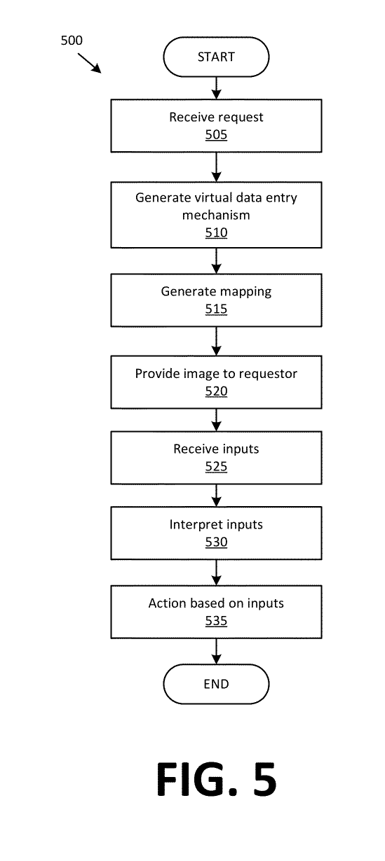

FIG. 5 illustrates an exemplary process for securely providing data from a user device 105 to a remote server 120. The process 500 begins in a block 505, in which the server 120 receives a request from the device 105 for validation that the device 105 can access some content. In this context, “content” may mean a website, a webpage, an application, an account, or other content to which access is restricted. For example, the device 105 may request access to a restricted webpage, a particular account such as a banking or other financial account, etc. When the server 120 recognizes such request, the process 500 proceeds to a block 510.

In the block 510, the server 120 generates a virtual data entry mechanism, e.g., a virtual keyboard or the like, to be provided in response to the request. For example, as stated above, the data store 125 could store information about parameters or requirements of a virtual data entry mechanism for a particular request. That is, the data store 125 could store information about a type of characters to be collected, e.g., letters, numbers, punctuation, other special characters, symbols, etc. Further, the data store 125 could store information about a number of characters to be collected and/or other information for generating a virtual data entry mechanism. In any event, based on such information, the server 120 generates a virtual data entry mechanism, e.g., a keyboard 300, 400, for collecting data required by the request. Moreover, particular elements in the data entry mechanism, e.g., keys 205, shapes, colors, images, etc., are arranged randomly within the data entry mechanism. For example, as shown in FIG. 3, keys 205 of a keyboard 300 may be randomly arranged.

Following the block 510, in a block 515, the server 120 generates a mapping between the randomly arranged elements of the data entry mechanism and particular data, e.g., characters, to be collected. That is, the server 120 determines a location of each data entry element such as a key 205 when the data entry mechanism, e.g., a keyboard 300, is presented in an image. As mentioned above, such location may be defined according to x and y coordinates, e.g., determined according to a location of a pixel or pixels in the data entry mechanism image. The server 120 stores the mapping in a memory for use when inputs are received from the device 105, as described below. Alternatively or additionally, the mapping could be provided to the device 105 for use as described below.

It will be apparent that the random arrangement of the data entry elements could be accomplished in a variety of ways. For example, if twenty-six data entry elements were to be represented, a list of the elements could be randomly sorted. Twenty-six locations in the data entry mechanism could then be defined, and the twenty-six data entry elements could be assigned to respective locations in the data entry mechanism according to their random sort order. Further, locations in the data entry mechanism could be randomly sized and shaped, again using randomizing techniques that will be apparent, e.g., within certain parameters, e.g., no location could be bigger that an X by Y pixel area, or smaller than a W by Z pixel area, etc. Moreover, as described above, data entry elements could be presented in multiple images, e.g., display in a sequence determined either by the server 120 or the client 105.

Next, in a block 520, the server 120 provides the data entry mechanism generated in the block 510 and mapped in the block 505 to the requesting device 105. For example, the server 120 may provide a webpage or the like to the device 105, included in which may be an image file representing the data entry mechanism. Additionally, it is possible, as just mentioned, that the mapping generated in the block 515 could also be provided to the device 105.

Next, in a block 525, the server 120 receives input data from the device 105, the input data representing user action, e.g., touchscreen selection, clicking or selecting with a pointing device, etc., with respect to the data entry mechanism. For example, a user may position a finger, a mouse arrow, etc. over a portion of the data entry mechanism representing a particular character, and select such portion. The client 105 may then provide coordinates of such selection to the server 120. Alternatively or additionally, if the mapping of the block 515 has been provided to the device 105, the device 105 could determine characters or other data indicated by a user selections, and could transmit such data to the server 120, e.g., according to a protocol such as is known for encrypting and securing communications via an open network. Further, a webpage, an interface in a mobile application, etc., may include other mechanisms for input, e.g., a button labeled “submit,” “go,”, etc., for indicating that input is complete, detecting that a predetermined number of characters has been entered, etc. Such webpage or other interface could also provide a form such as is known for displaying input data, e.g., a selected character, shape, etc. Further, where multiple images are provided, the client 105 could store input for each of a plurality of images presented in sequence, which input could be transmitted to a server 120 upon indication that it was complete, e.g., by a specified number of characters having been entered, by a submit button or the like being selected, etc.

In a block 530, which following the block 525, the server 125 interprets inputs received from the device 105. If the device 105 has already interpreted the mapping of the block 515, and has provided character data or the like, then the block 530 may simply include decrypting or otherwise interpreting such data. However, if the device 105 has provided coordinates of user selections in the display 110, e.g., an array or some other data structure with in indexed list or set of coordinates, each coordinate corresponding to a character or other datum in a string of data, e.g., a username, account number, etc., being provided, then the server 120 may use the map of the block 515 to identify a provided character or characters or other data. That is, particular coordinates provided from the user device 105 will correspond to a particular character or other datum.

Next, in a block 535, the server 120 takes some action based on the input or inputs received in the block 530. For example, by checking data received and interpreted as described in the block 530 against data stored in the data store 125, the server 120 may be able to validate a username, password, and/or account number, etc., against input provided from the device 105. If such validation cannot be performed, and action by the server 120 may be to provide a message to the client 105 stating that validation was unsuccessful, requesting that input be provided again, etc. However, if data received in the block 530 can be validated, action by the server 120 could include granting access to an account, webpage, application, etc., based on the validated data.

Following the block 535, the process 500 ends.

### CONCLUSION

Computing devices 105, 120, etc., may employ any of a number of computer operating systems, including, but by no means limited to, versions and/or varieties of the Microsoft Windows® operating system, the iOS by Apple Computer, Inc., Android by Google, Inc., the Unix operating system (e.g., the Solaris® operating system distributed by Sun Microsystems of Menlo Park, Calif.), the AIX UNIX operating system distributed by International Business Machines (IBM) of Armonk, N.Y., and the Linux operating system. Computing devices in general may include any one of a number of computing devices, including, without limitation, a computer workstation, a desktop, notebook, laptop, or handheld computer, or some other computing device.

Computing devices such as those discussed herein generally each include instructions executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases or data stores described herein, e.g., data store 145, etc., may include various kinds of mechanisms for storing, accessing, and retrieving various kinds of data, including a hierarchical database, a set of files in a file system, an application database in a proprietary format, a relational database management system (RDBMS), etc. Each such database or data store is generally included within a computing device employing a computer operating system such as one of those mentioned above, and are accessed via a network in any one or more of a variety of manners. A file system may be accessible from a computer operating system, and may include files stored in various formats. An RDBMS generally employs Structured Query Language (SQL) in addition to a language for creating, storing, editing, and executing stored procedures, such as the PL/SQL language mentioned above. Database 115 may be any of a variety of known RDBMS packages, including IBMS DB2, or the RDBMS provided by Oracle Corporation of Redwood Shores, Calif.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A first computing device comprising a processor and a memory, the memory storing instructions executable by the processor to:
receive a request for validation;
generate, based on the request, a virtual data entry mechanism that includes randomly arranged data entry elements; and
provide the virtual data entry mechanism to a second computing device.

2. The device of claim 1, wherein the first computing device is further configured to map each of the data entry elements to a location in the data entry mechanism.

3. The device of claim 2, wherein the location includes coordinates of at least one pixel in an image included in the data entry mechanism.

4. The device of claim 2, wherein the first computing device is further configured to provide the map to the second computing device.

5. The device of claim 4, wherein the first computing device is further configured to receive, from the second computing device, data resulting from the second computing device having interpreted the map.

6. The device of claim 2, wherein the first computing device is further configured to receive at least one location in the data entry mechanism of a user selection, and to use the map to determine an input based on the received at least one location.

7. The device of claim 1, wherein the data entry elements include virtual keys that each are associated with a character.

8. The device of claim 1, wherein the data entry mechanism includes randomly generated shapes.

9. The device of claim 1, wherein the first computing device is further configured to perform the validation.

10. The device of claim 1, wherein the data entry mechanism includes a plurality of images.

11. A method, comprising
receiving, in a first computing device, a request for validation;
generating, based on the request, a virtual data entry mechanism that includes randomly arranged data entry elements; and
providing the virtual data entry mechanism to a second computing device.

12. The method of claim 11, further comprising mapping each of the data entry elements to a location in the data entry mechanism.

13. The method of claim 12, wherein the location includes coordinates of at least one pixel in an image included in the data entry mechanism.

14. The method of claim 12, further comprising providing the map to the second computing device.

15. The method of claim 14, further comprising receiving, in the first computing device, data resulting from the second computing device having interpreted the map.

16. The method of claim 12, further comprising receiving at least one location in the data entry mechanism of a user selection, and to using the map to determine an input based on the received at least one location.

17. The method of claim 11, wherein the data entry elements include virtual keys that each are associated with a character.

18. The method of claim 11, wherein the data entry mechanism includes randomly generated shapes.

19. The method of claim 11, further comprising performing the validation.

20. The method of claim 11, wherein the data entry mechanism includes a plurality of images.
